(19) United States
(12) Patent Application Publication
(10) Pub. No.: US 2025/0392066 A1
(43) Pub. Date: Dec. 25, 2025

(54) CONNECTOR AND CONNECTOR ASSEMBLY

(71) Applicant: Molex, LLC, Lisle, IL (US)

(72) Inventors: Satoshi Tanaka, Yamato (JP); Taichi Taniguchi, Yamato (JP)

(21) Appl. No.: 19/246,717

(22) Filed: Jun. 24, 2025

(30) Foreign Application Priority Data
Jun. 24, 2024 (JP) 2024-100947

(51) Int. Cl. H01R 13/05; H01R 13/502

(52) U.S. Cl. CPC H01R 13/05; H01R 13/502

(57) ABSTRACT

A connector, including: a housing, a plurality of terminals and a reinforcing metal fitting attached to the housing, wherein the housing includes a pair of side walls and a pair of end walls connected to each end of the side walls, the side walls supporting the terminals, and the reinforcing metal fitting connected to the end walls; the terminal includes a board connecting part extending in a width direction of the connector, a second contact part with a first end connected to the board connecting part, and a first contact part with a second end connected to the second contact part; the side wall includes a bottom plate part, and a convex wall protruding from the bottom plate part in the mating direction; and the first contact surface having the first contact part is exposed to a first side surface and a second side surface of the convex wall at positions corresponding to the first side surface and the second side surface of the convex wall, and a second contact surface having the second contact part is exposed to a first side and a second side of the convex wall at positions offset inward in the width direction from the first side surface and the second side surface of the convex wall.

### TECHNICAL FIELD

The present disclosure relates to a connector and a connector assembly.

### BACKGROUND

Conventionally, connectors such as board-to-board connectors have been used to electrically connect pairs of parallel circuit boards to each other. These types of connectors are attached to both opposing surfaces of a pair of circuit boards and fitted together to ensure electric conduction (for example, see Patent Reference 1).

FIG. 23 is a cross-section view depicting a conventional connector.

In the drawing, 811 is a connector housing mounted on a circuit board (not illustrated), which has a pair of convex parts 812 extending in the longitudinal direction thereof. Furthermore, a plurality of terminals 861 are mounted to the convex parts 812 side by side in the longitudinal direction of the connector. Each terminal 861 includes a board connecting part 862 that is connected to the circuit board, and a contact part 863 that contacts with a counterpart terminal of a counterpart connector (not depicted).

Moreover, when the connector is mated with a mating connector, the convex parts 812 are inserted into each of the pair of recessed grooves formed in the mating housing of the mating connector. As a result, the contact part 863 of the terminals 861 is in contact with and conducts with each of the mating terminals mounted side by side in the recessed groove.

### SUMMARY

However, in conventional connectors, the terminals 861 are integrated with the housing 811, making the connector more compact and reducing the gap between the convex parts 812, thereby reducing the pitch between the terminals 861. Consequently, production of the connector is more difficult. The terminals 861 are usually formed so as to be integrated with the pair of convex parts 812 of the housing 811 using a method of molding referred to as overmolding or insert molding. Using this method leads to a narrower gap between the convex parts 812 and narrower pitch between the terminals 861, making it difficult to precisely deploy a large number of terminals 861 in a mold for molding the housing 811 corresponding to the pair of convex parts 812.

Furthermore, when the connector is made to be low-profile, ensuring a sufficient distance between the board connecting part 862 and the contact part 863 of each terminal 861 may be impossible, which may result in poor connection due to solder wicking.

An object of the present invention is to provide a connector and connector assembly which overcomes the aforementioned problems of the conventional technology, is easy to manufacture, can be made compact and thin, and is highly reliable.

Therefore, the connector is a connector, including: a housing, a plurality of terminals and a reinforcing metal fitting attached to the housing, wherein the housing includes a pair of side walls and a pair of end walls connected to each end of the side walls, the side walls supporting the terminals, and the reinforcing metal fitting connected to the end walls; the terminal includes a board connecting part extending in a width direction of the connector, a second contact part with a first end connected to the board connecting part, and a first contact part with a second end connected to the second contact part; the side wall includes a bottom plate part, and a convex wall protruding from the bottom plate part in the mating direction; and the first contact surface having the first contact part is exposed to a first side surface and a second side surface of the convex wall at positions corresponding to the first side surface and the second side surface of the convex wall, and a second contact surface having the second contact part is exposed to a first side and a second side of the convex wall at positions offset inward in the width direction from the first side surface and the second side surface of the convex wall.

In another connector, the bottom plate part includes a flange, a portion of the surface of the second contact part side end of the board connecting part is covered by the flange, and the side end of the board connecting part opposite the second contact part is exposed outside the flange when viewed from the mating direction.

In yet another connector, the first end of the second contact part is connected to the first contact part via a connecting part, and the second end of the second contact part is embedded in the bottom plate part.

In yet another connector, a free end of the first contact part is embedded in the bottom plate part, and an end surface of the free end is at least partially exposed when viewed from the lower surface side of the bottom plate part.

In yet another connector, a terminal supported on a first side wall and a terminal supported on a second side wall at a position opposite to the aforementioned terminal in the width direction of the connector are in the same orientation when viewed from the longitudinal direction of the connector.

In yet another connector, the board connecting part of a terminal supported on the first side wall and extending toward the second side wall and the board connecting part of a terminal supported on the second side wall and extending toward the first side wall are arranged in a staggered pattern with a half pitch offset from each other.

A connector assembly includes the connector according to the present disclosure, and a counterpart connector that mates with the aforementioned connector.

The present disclosure enables narrowing the pitch between terminals in a terminal row, narrowing the gap between terminal rows, preventing occurrence of solder bridging, simplifying manufacturing, size reduction even when there are multiple poles, and improving reliability.

### BRIEF DESCRIPTION OF THE DRAWINGS

FIG. 1 is a perspective view of a first connector according to the present embodiment;

FIG. 2 is an exploded view of the first connector according to the present embodiment;

FIG. 3 is a perspective view depicting the metal member arrangement of the first connector according to the present embodiment;

FIGS. 4A-4C are a three-view drawing of the first connector according to the present embodiment, where FIG. 4A is a top view, FIG. 4B is a side view, and FIG. 4C is a bottom view;

FIGS. 5A and 5B are a cross-sectional view of the first connector according to the present embodiment;

FIGS. 6A and 6B include perspective views including a cross-section of the first connector according to the present embodiment, where FIG. 6A is a perspective view including a cross section along arrow A-A in FIG. 4A, and FIG. 6B is a perspective view including a cross-sectional view along arrow B-B in FIG. 4A;

FIG. 7 is a first perspective view of a pair of left and right half parts of the first connector according to the present embodiment;

FIG. 8 is a perspective view of a left half body part of the first connector according to the present embodiment;

FIG. 9 is an exploded view of the left half body part of the first connector according to the present embodiment;

FIGS. 10A and 10B include second and third perspective views of a left and right pair of half body parts of the first connector of the present embodiment, where FIG. 10A is the second perspective view and FIG. 10B is a third perspective view;

FIG. 11 is a perspective view depicting a first step to produce the left half body part of the first connector according to the present embodiment;

FIG. 12 is a perspective view depicting a second step to produce the left half body part of the first connector according to the present embodiment;

FIG. 13 is a plan view depicting a second step to produce the left half body part of the first connector according to the present embodiment;

FIG. 14 is a top view depicting a step of joining the left and right half body parts of the first connector according to the present embodiment;

FIGS. 15A and 15B are a two view diagram depicting a first step to produce a first protruding end part of the first connector according to the present embodiment, wherein FIG. 15A is a top view, and FIG. 15B is a bottom view;

FIGS. 16A and 16B are a two view diagram depicting a second step to produce a first protruding end part of the first connector according to the present embodiment, wherein FIG. 16A is a top view, and FIG. 16B is a bottom view;

FIG. 17 is a perspective view of a second connector according to the present embodiment;

FIGS. 18A-18C are a three-view drawing of the second connector according to the present embodiment, where FIG. 18A is a top view, FIG. 18B is a side view, and FIG. 18C is a bottom view;

FIG. 19 is a perspective view viewed from the first connector side to illustrate the state immediately prior to mating of the first connector and a second connector according to the present embodiment;

FIG. 20 is a perspective view viewed from the first connector side depicting the state of the first connector and the second connector mated according to the present embodiment;

FIGS. 21A-21C are a three view diagram depicting the first connector and second connector of the present embodiment in a mated state where FIG. 21A is a plan view of the first connector as viewed from the side, FIG. 21B is a cross sectional view along line C-C, and FIG. 21C is a cross sectional view along line D-D;

FIGS. 22A and 22B are perspective views including a cross-section of the first connector and the second connector according to the present embodiment in a mated state, where FIG. 22A is a perspective view including a cross section along arrow C-C in FIG. 21A, and FIG. 22B is a perspective view including a cross-sectional view along arrow D-D in FIG. 21A; and

FIG. 23 is a perspective view depicting a conventional connector.

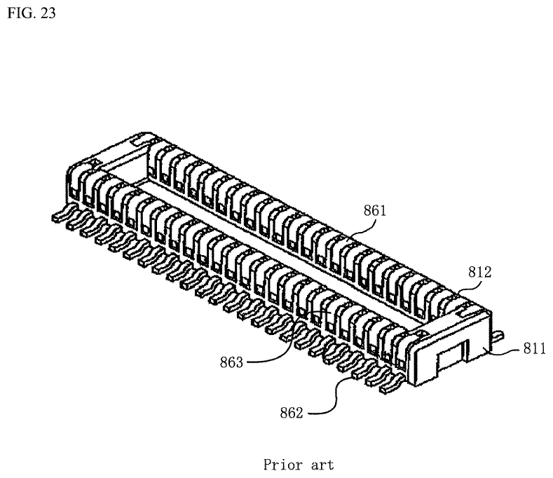

### DETAILED DESCRIPTION

Embodiments will hereinafter be described in detail with reference to the drawings.

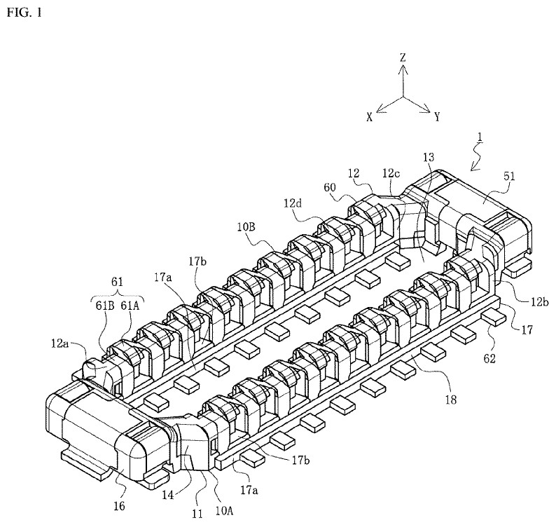

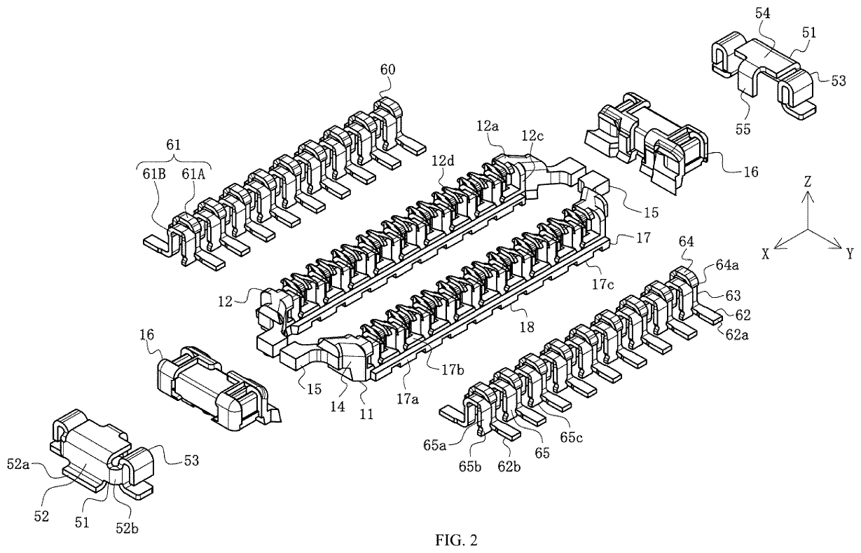

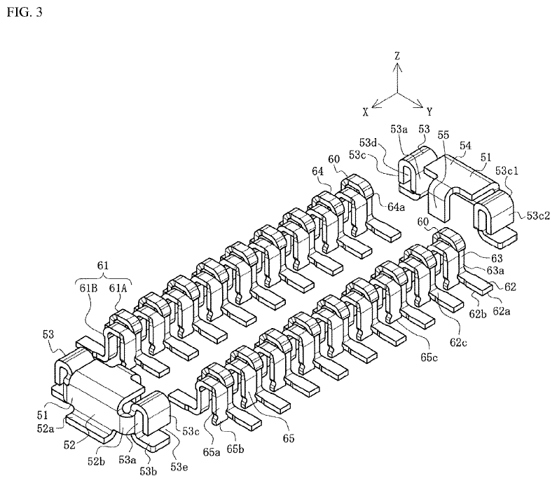

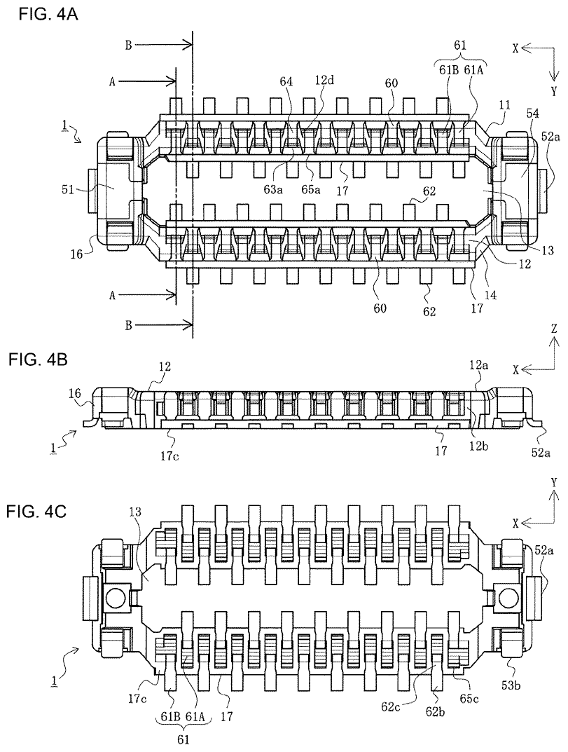

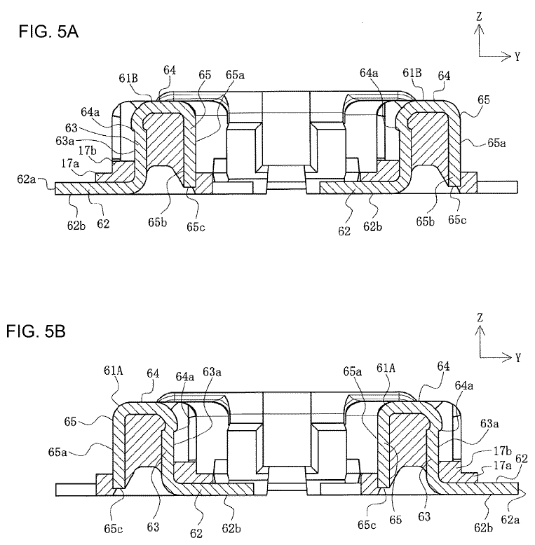

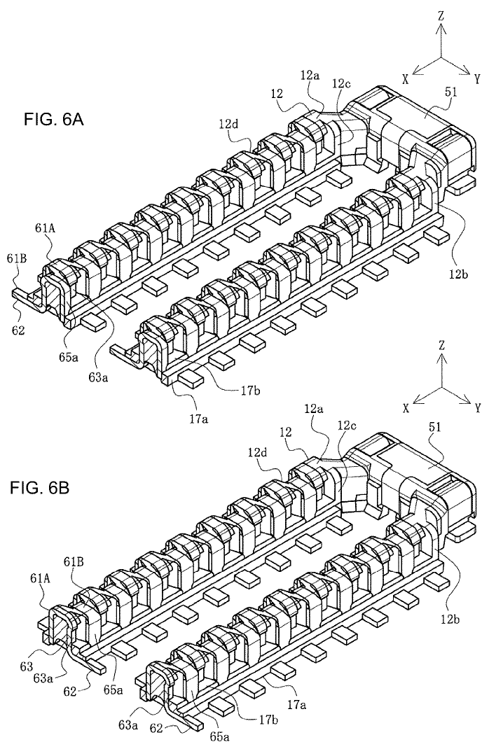

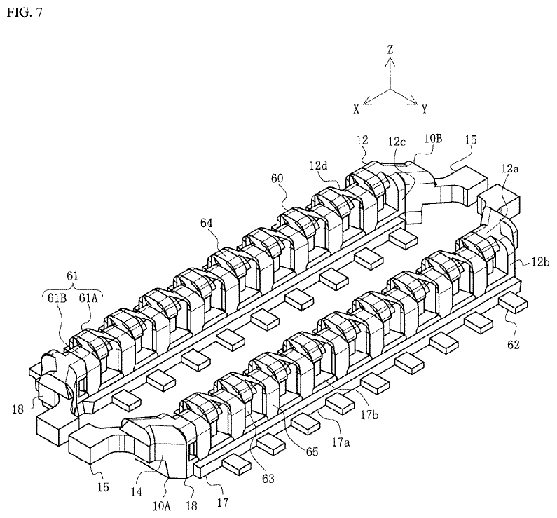

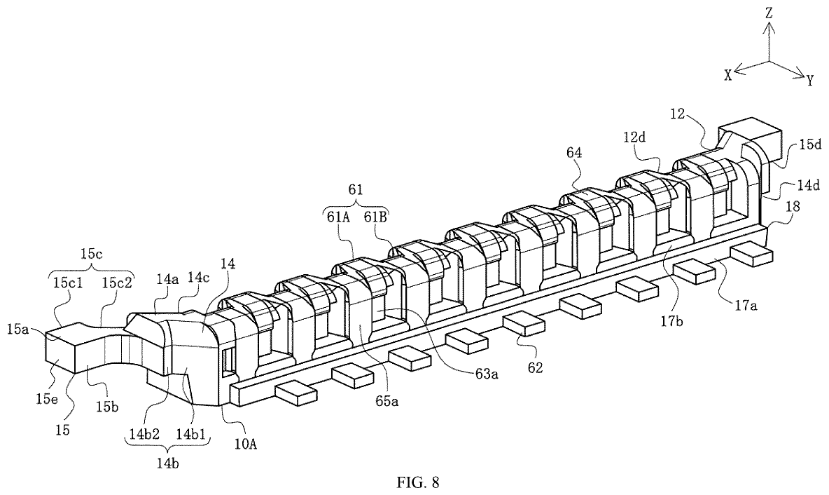

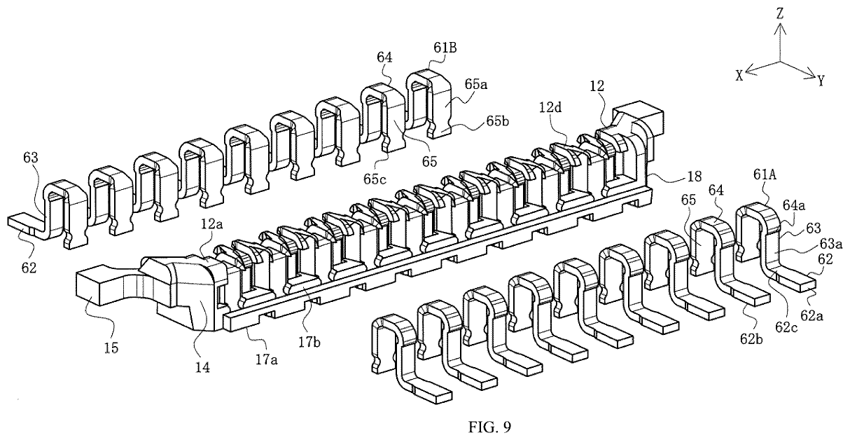

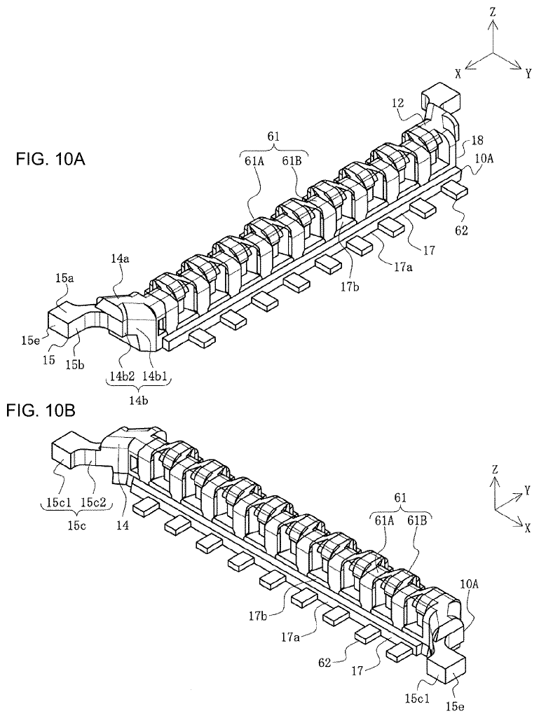

FIG. 1 is a perspective view of the first connector according to the present embodiment; FIG. 2 is an exploded view of the first connector according to the present embodiment; FIG. 3 is a perspective view showing the metal member arrangement of the first connector according to the present embodiment; FIGS. 4A-4C are a three view diagram of the first connector according to the present embodiment; FIGS. 5A and 5B are a cross-sectional view of the first connector according to the present embodiment; FIGS. 6A and 6B are a perspective view including a cross-section of the first connector according to the present embodiment; FIG. 7 is a first perspective view of a pair of left and right half parts of the first connector according to the present embodiment; FIG. 8 is a perspective view of a left half body part of the first connector according to the present embodiment; FIG. 9 is an exploded view of a left half body part of the first connector according to the present embodiment; and FIGS. 10A and 10B depict a second and third perspective view of a pair of left and right half parts of the first connector according to the present embodiment. It should be noted that in FIGS. 4A-4C, FIG. 4A is a top view, FIG. 4B is a side view, and FIG. 4C is a bottom view; in FIGS. 5A and 5B, FIG. 5A is a cross-sectional view taken along arrow A-A in FIG. 4A, and FIG. 5B is a cross-sectional view taken along arrow B-B in FIG. 4A; in FIGS. 6A and 6B, FIG. 6A is a perspective view including a cross-section viewed along arrow A-A in FIG. 4A, and FIG. 6B is a perspective view including a cross-section viewed along arrow B-B in FIG. 4A; and in FIGS. 10A and 10B, FIG. 10A is a second perspective view and FIG. 10B is a third perspective view.

In the diagrams, 1 is a first connector as one of a pair of board-to-board connectors that are connectors of the present embodiment. The first connector 1 is a surface mounting type connector mounted on the surface of a first board (not illustrated) serving as a mounting member and is mated to a second connector 101 (described below) that serves as a mating connector. Furthermore, the second connector 101 is the other of the pair of board-to-board connectors and is a surface mount type connector mounted on the surface of a second board (not depicted) serving as a mounting member. Furthermore, the first connector 1 and the second connector 101 constitute a connector pair or a connector assembly.

It should be noted that the first connector 1 and the second connector 101 according to the present embodiment are preferably used to electrically connect a first board to a second board, but can also be used to electrically connect other members. For example, the first board and the second board are each a printed circuit board, a flexible flat cable (FFC), a flexible circuit board (FPC), or the like as used in electronic devices or the like, but may be any type of board.

In addition, in the present embodiment, expressions indicating direction such as top, bottom, left, right, front, rear, and the like used to describe the configuration and operation of each part of the first connector 1 and the second connector 101 are relative rather than absolute and are appropriate when each part of the first connector 1 and the second connector 101 are in the positions depicted in the drawings; that said, these directions should be interpreted as changing in accordance with the change in position when the position thereof is changed.

Furthermore, for example, the first connector 1 has dimensions of a length (size in the X-axis direction) of about 6.0 mm, a width (size in the Y-axis direction) of about 2.0 mm, and a height (size in the Z-axis direction) of about 0.5 mm. However, the dimensions can be changed as appropriate.

Furthermore, the first connector 1 is composed of a pair of right and left half body parts, or a left half body part 10A and a right half body part 10B, joined by a first reinforcing fitting 51 as a reinforcing fitting, or in other words a nail, and a first protruding end part 16 as a cover part that is integrally molded by a method of molding called over-molding, outsert molding, or insert molding (hereinafter, referred to as “insert molding”). Note that as the left half body part 10A and the right half body part 10B are the same members arranged so as to face each other on the left and right sides, they will be described as half body part 10 when comprehensively described. The left half body part 10A and the right half body part 10B are each substantially gate shaped (a shape projected on the X-Y plane) in a plan view, with the space between the left half body part 10A and the right half body part 10B that are joined together being a long and narrow recessed groove part 13 extending in the longitudinal direction (X-axis direction) of the first connector 1. The recessed groove part 13 is a through hole that is open on the upper surface and the lower surface of the first connector 1.

Note that in the present embodiment, for convenience of description, the first connector 1 is described as having a pair of half body parts 10, that is, a configuration in which two of the half body parts 10 are arranged in parallel; however, three or more of the half body parts 10 may be arranged in parallel. Furthermore, the half body part 10 does not necessarily need to be substantially gate shaped and may have any shape provided that both ends in the longitudinal direction can be joined by the first reinforcing fitting 51 and the first protruding end part 16.

Furthermore, in the present embodiment, the recessed groove part 13 is described as one through-hole, but may be a hole with a bottom having a bottom plate. In addition, the bottom plate may have a plurality of through-holes and in this case, the through-holes are desirably set to enable visually confirming a tail part 62 of the first terminals 61 positioned in the recessed groove part 13. Thus, the appearance and the like of the connected state of the tail part 62 and the board by means of soldering or the like can easily be confirmed from the outside.

The first connector 1 has a first housing 11 which is integrally formed from an insulating material such as synthetic resin or the like and has a generally gate-like shape in plan view. The first housing 11 has a pair of side walls 18 extending in the longitudinal direction (X-axis direction), the side walls 18 are parallel to each other, and both ends of the side walls 18 are connected by a pair of first protruding end parts 16. It should be noted that the pair of first protruding end parts 16 may also be referred to as a pair of end walls of the first connector 1. Each side wall 18 includes an elongated strip-shaped bottom plate part 17 extending in the longitudinal direction (X-axis direction) of the first housing 11, and a first convex part 12 as a convex wall which is an elongated convex part extending in the longitudinal direction of the first housing 11 and integrally formed on the upper surface of the bottom plate part 17. In other words, the side wall 18 includes a bottom plate part 17, and a first convex part 12 as a convex wall protruding from the bottom plate part 17 in the mating direction (positive direction of the Z axis). The pair of first convex parts 12 face each other and are parallel to each other, and the pair of first protruding end parts 16 also face each other and are parallel to each other.

The first convex part 12 is a member whose cross-section is shaped like an upside-down U, and has a mating surface 12a which is located on the upper side (positive Z-axis direction side), and acts as the upper surface facing upward, an outer surface 12b which is one side surface connected to the left and right sides of the mating surface 12a, and an inner surface 12c which is the other side surface. The outer surface 12b is a surface facing outward in the width direction (Y-axis direction) of the first housing 11 and the inner surface 12c is a surface facing inward, toward the recessed groove part 13, in the width direction of the first housing 11. Furthermore, the outer surface 12b and the inner surface 12c are a pair of flat surfaces that face each other in parallel and extend in the longitudinal direction of the first housing 11.

In addition, the first terminals 61 are terminals disposed on each first convex part 12. The first terminals 61 are arranged at a prescribed pitch and are provided in plurality. The first terminal 61 is a member integrally formed by carrying out processing such as punching and bending on a conductive metal plate. It should be noted that the first housing 11 is integrally formed with the first terminals 61 by insert molding. In other words, the first housing 11 is molded by setting the first terminals 61 inside and then filling in the cavity of the metal mold with an insulating material. Therefore, the first terminals 61 do not exist separated from the first housing 11, or in other words, the shape depicted in FIG. 2 and FIG. 9 where the location of the first terminals 61 mounted in the first housing 11 in a state where the first terminals 61 are separated does not exist. It should be noted that the depictions in FIG. 2 and FIG. 9 are solely for the convenience of description. Furthermore, similarly, the first reinforcing fitting 51 is not spaced apart from the first protruding end part 16, and the location where the first reinforcing fitting 51 is attached to the first protruding end 16 is not spaced apart from the first reinforcing fitting 51 and does not have the shape depicted in FIG. 2 and the like. It should be noted that the depictions in FIG. 2 and the like are solely for the convenience of description.

The present embodiment includes a plurality of first terminals 61, which are attached to and supported by the first convex part 12 of the side wall 18, forming a plurality of terminal rows 60 that extend in the longitudinal direction of the first connector 10. In the first housing 11, a plurality of side walls 18 are integrally connected to the first protruding end parts 16 so the plurality of terminal rows 60 are also retained on the first convex part 12 of the first housing 11 and can be said to be integrally connected.

In addition, the first terminals 61 include a first type of terminal first terminals 61A and a second type of terminal first terminals 61B. Furthermore, in each terminal row 60, the first terminals 61A and the first terminals 61B are arranged alternately. In addition, a first terminal row 60 and an adjacent second terminal row 60 are arranged so that the first terminals 61A and the first terminals 61B are lined up in the width direction (Y-axis direction) of the first connector 10. Note that in the example depicted in the figures, nine first terminals 61A and nine first terminals 61B are arranged at a prescribed pitch (for example, approximately 0.15 to 0.18 [mm]) in each of the terminal rows 60, but the number and pitch of the first terminals 61 in each of the terminal rows 60 can be changed as appropriate.

It should be noted that the first convex part 12 includes an inter-terminal wall 12d interposed between mutually adjacent first terminals 61 in the terminal rows 60, or in other words, between the first terminals 61A and the first terminals 61B that are mutually adjacent. The inter-terminal wall 12d is a portion that maintains insulation between mutually adjacent first terminals 61 in the terminal rows 60.

Furthermore, the bottom plate part 17 is positioned at the bottom, protrudes to the outside of the outer surface 12b in the width direction of the first housing 11, and includes a lower plate part 17a as a plate-shaped flange that protrudes to the inside of the inner surface 12c in the width direction of the first housing 11 and a plate shaped upper plate part 17b that is positioned above the lower plate part 17a, in which both ends thereof, in the width direction of the first housing 11, are approximately in the same positions as the outer surface 12b and inner surface 12c. In addition, a lower surface 17c of the bottom plate part 17 is a mounting surface of the first housing 11 facing the surface of the first board.

The first terminal 61 is a member integrally formed by carrying out processing such as punching and bending on a conductive metal plate. It should be noted that the first terminals 61A and 61B are substantially identical, but are arranged so as to face in opposite left and right directions when viewed from the longitudinal direction (X-axis direction) of the first connector 1. The first terminals 61 supported by one side wall 18 and the first terminals 61 supported by the other side wall 18 at a position opposite to the first terminals 61 in the width direction (Y-axis direction) of the first connector 1 have the same orientation when viewed from the longitudinal direction of the first connector 1.

Furthermore, the first terminals 61 include an inner column part 63 as a second contact part extending in the vertical direction (Z-axis direction), a tail part 62 as a board connecting part that protrudes from the lower end of the inner column part 63 toward the widthwise outer direction of the first convex part 12, an outer column part 65 as a first contact part extending in the vertical direction opposite the inner column part 63, and a bent connecting part 64 that connects the upper end of the outer column part 65 to the upper end of the inner column part 63. In other words, one end of the inner column part 63 is connected to the outer column part 65 via the connecting part 64, and the other end of the inner column part 63 is embedded in the bottom plate part 17.

The widthwise outer surface of the first convex part 12 in the inner column part 63 is a second contact surface 63a that functions as a contact surface that contacts the second terminal 161 of the second connector 101 described later, and the widthwise outer surface of the first convex part 12 in the outer column part 65 is a first contact surface 65a that functions as a contact surface that contacts the second terminal 161 of the second connector 101 described later. Furthermore, an anchor part 65b having an anchor shape that is embedded in the bottom plate part 17 of the side wall 18 and that does not disconnect is formed at a free end, or in other words, the lower end, of the outer column part 65. Furthermore, an upper end convex part 64a is formed so as to protrude outward in the width direction of the first convex part 12 at the boundary between the upper end of the inner column part 63 and the connecting part 64. Furthermore, an end surface 62a at the tip of the tail part 62 is a cross section produced by separation from a connecting arm 68a of a terminal carrier 68, described below. Furthermore, the lower surface 62b of the tail part 62 is adjacent to the end surface 62a and connected to the conductive trace of the first board and is a connecting surface that is connected, by means of soldering or the like, to a connection pad formed on a surface of the first board. Note that the conductive trace is typically a signal line but also may be a power line.

Each first terminal 61 is a member formed by bending a long, thin metal strip extending in the width direction (Y-axis direction) of the first connector 1 in the up-down direction (Z-axis direction), but the dimension in the width direction (X-axis direction) is preferably not uniform. Specifically, the tail part 62 and the outer column part 65 are preferably formed to be wide (for example, about 0.1 mm), and the inner column part 63 and the connecting part 64 are preferably formed to be narrow (for example, about 0.075 mm). As a result, the widthwise (X-axis) dimension of the first contact surface 65a of the outer column part 65 and the lower surface 62b of the tail part 62 are larger than the second contact surface 63a of the inner column part 63 and the upper surface of the connecting part 64. It should be noted that the adjacent part 62c of the tail part 62 adjacent to the inner column part 63 is preferably formed with a narrow width similar to the inner column part 63.

As described above, in each of the terminal rows 60, the first terminals 61A and first terminals 61B are alternately arranged, or a first terminal row 60 and an adjacent terminal row 60 are arranged so the first terminals 61A are mutually aligned and the first terminals 61B are mutually aligned, with regards to the width direction (Y-axis direction) of the first connector 10. Therefore, in the example depicted in FIG. 4A, the first terminal 61 located at the front end (end in the positive direction on the X-axis) of the terminal row 60 located on the lower side is the first terminal 61B, and the orientation is such that the tail part 62 protrudes toward the inside in the width direction of the first connector 10, whereas the first terminal 61 located second from the front end is first terminal 61A, and the orientation is such that the tail part 62 protrudes toward the outside in the width direction of the first connector 10. In this manner, the first terminals 61 are mounted on the first convex part 12 arranged in a line in mutually opposing directions, so the pitch of the tail parts 62 protruding from both sides of the first convex part 12 is twice that of the pitch of the first terminal 61. In addition, the tail part 62 of the first terminal 61 supported by one side wall 18 and extending toward the other side wall 18, and the tail part 62 of the first terminal 61 supported by the other side wall 18 and extending toward one side wall 18 are arranged so as to be mutually shifted by half a pitch in a staggered pattern. This configuration facilitates the operation of connecting the first terminal to the connection pad of the first board by soldering or the like.

Furthermore, with the first terminals 61 in a state of being integrated with the first housing 11, the upper surface of the connecting part 64 is positioned roughly the same as the mating surface 12a that is the upper surface of the first convex part 12. In other words, the upper surface of the connecting part 64 of each of the first terminals 61 is substantially flush with the mating surface 12a of the first convex part 12.

Furthermore, the first contact surface 65a of the outer column part 65 of the first terminal 61 is substantially flush with the outer surface 12b and the inner surface 12c of the first convex part 12 of the side wall 18. In other words, the first contact surface 65a of each first terminal 61 is located in a position corresponding to the outer surface 12b and the inner surface 12c on both sides of the first convex part 12, in the width direction (Y-axis direction) of the first connector 10. On the other hand, the second contact surface 63a of the inner column part 63 of the first terminal 61 is located inside the outer surface 12b and the inner surface 12c of the first convex part 12 in the width direction (Y-axis direction) of the first convex part 12. In other words, the second contact surface 63a of each first terminal 61 is shifted and offset on both sides of the first convex part 12 in the width direction (Y-axis direction) of the first connector 10, so as to be recessed more inward in the width direction of the first convex part 12 than the first contact surface 65a.

In this manner, the first contact surface 65a and the second contact surface 63a serving as the contact surface between adjacent first terminals 61 are shifted and offset in each terminal row 60 in the width direction of the first convex part 12.

Note that for each of the terminal rows 60, there are inter-terminal walls 12d between adjacent inner column parts 63, outer column parts 65, and connecting parts 64 of adjacent first terminals 61, and these inter-terminal walls 12d are integrated with the inner column parts 63, outer column parts 65, and connecting parts 64. As a result, insulation is reliably maintained between adjacent first terminals 61 while the first terminals 61 are firmly retained in the first convex parts 12 of the side wall 18.

Furthermore, the tail part 62 and the outer column part 65 are formed to be wide, and the inner column part 63 and the connecting part 64 are formed to be narrow. In addition, the adjacent part 62c of the tail part 62 adjacent to the inner column part 63 is also formed to have a narrow width similar to the inner column part 63.

As a result, the gap between adjacent connecting parts 64 can be maintained wide in the longitudinal direction (X-axis direction) of the first convex part 12, and insulation between adjacent connecting parts 64 can be reliably maintained, on the mating surface 12a, which is the upper surface of the first convex part 12. Furthermore, the gap between adjacent connecting parts 64 is wide, so when the insulating material constituting the first housing 11 is filled by insert molding, the gap between adjacent connecting parts 64 is also filled reliably.

In addition, the second contact surfaces 63a of the inner column part 63 are located on both sides of the first contact surfaces 65a of each outer column part 65 on the outer surface 12b and the inner surface 12c, which are the left and right side surfaces of the first convex part 12. In other words, the wide first contact surfaces 65a and the narrow second contact surfaces 63a are arranged alternately in the longitudinal direction (X-axis direction) of the first convex part 12 on the outer surface 12b and the inner surface 12c. As a result, the gap between adjacent first contact surfaces 65a and second contact surfaces 63a can be maintained wide in the longitudinal direction of the first convex part 12, and insulation between adjacent first contact surfaces 65a and second contact surfaces 63a is reliably maintained on both the left and right sides of the first convex part 12. In addition, the gap between adjacent first contact surfaces 65a and second contact surfaces 63a is wide, so when the insulating material constituting the first housing 11 is filled by insert molding, the gap between the adjacent first contact surfaces 65a and second contact surfaces 63a is also reliably filled.

Furthermore, as described above, the first contact surface 65a and the second contact surface 63a are shifted and offset in the width direction of the first convex part 12, so the gap between adjacent first contact surfaces 65a and second contact surfaces 63a corresponds to the distance of a vector obtained by combining a vector representing the distance in the X-axis direction and a vector representing the distance in the Y-axis direction, and thus is even wider than the distance in the X-axis direction. Therefore, insulation between adjacent first contact surfaces 65a and second contact surfaces 63a is more reliably maintained, and the space between the adjacent first contact surfaces 65a and second contact surfaces 63a is more reliably filled with insulating material.

It should be noted that the second contact surface 63a is shifted and offset with respect to the width direction of the first convex part 12 so as to be recessed more inward in the width direction of the first convex part 12 than the first contact surface 65a, and therefore, as can be seen when viewed from the mating direction (Z-axis direction) of the first connector 1, adjacent parts 62c adjacent to the inner column part 63 in the tail part 62 are located on both sides of the anchor part 65b, which is the lower end of the outer column part 65. In other words, near the lower end of the outer surface 12b and the inner surface 12c, the wide anchor parts 65b and the narrow adjacent parts 62c are arranged alternately in the longitudinal direction of the first convex part 12. As a result, near the lower ends of both the left and right sides of the first convex part 12, the gap between adjacent anchor parts 65b and adjacent parts 62c can be maintained wide in the longitudinal direction of the first convex part 12, insulation between adjacent anchor parts 65b and adjacent parts 62c is reliably maintained, and insulating material is reliably filled between adjacent anchor parts 65b and adjacent parts 62c.

In addition, the lower surface 62b of the tail part 62 is substantially at the same position as the lower surface 17c of the bottom plate part 17, in other words, substantially flush with the lower surface 17c of the bottom plate part 17. Furthermore, the lower surface 62b of the tail part 62 is exposed from the lower surface 17c of the bottom plate part 17. On the other hand, the end surface of the free end of the outer column part 65, or in other words the lower surface 65c of the anchor part 65b, is located at a higher position (positive direction of the Z-axis) than the lower surface 17c of the bottom plate part 17, as depicted in FIGS. 5A and 5B, but at least a portion is exposed when viewed from the mounting surface (lower surface 17c) side.

It should be noted that the lower plate part 17a of the bottom plate part 17 that protrudes outward in the width direction of the first convex part 12 covers at least a portion of the upper surface of the tail part 62 of the first terminal 61. Specifically, a portion of the surface of the side end of the inner column part 63 in the tail part 62, preferably the entire surface of the adjacent part 62c, is covered by the lower plate part 17a. More preferably, as depicted in FIGS. 5A and 5B, at least the midpoint of the range from the point adjacent to the inner column part 63 to the end surface 62a of the tail part 62 in the width direction (Y-axis direction) of the first convex part 12 is covered. Furthermore, the anchor part 65b located on the opposite side of the tail part 62 in the width direction of the first convex part 12 is embedded in the bottom plate part 17. Thereby, the first terminal 61 including the tail part 62 and the anchor part 65b is more firmly held by the first convex part 12 of the side wall 18. It should be noted that the end of the tail part 62 opposite the inner column part 63 is exposed to the outside of the lower plate part 17a when viewed from the mating direction (Z-axis direction).

Furthermore, as described above, the tail part 62 is wide, so the connection strength is high in the tail part 62 having a lower surface 62b connected to a connection pad formed on the surface of the first board by a connecting agent such as solder or the like, and the first terminal 61 including the tail part 62 is firmly connected to the first board.

It should be noted that, a connecting agent such as solder or the like is applied to a portion that protrudes outward from the bottom plate part 17 on the lower surface 62b of the tail part 62. However, the distance from that portion to the second contact surface 63a exposed on both the left and right side surfaces of the first convex part 12 is long in the width direction (Y-axis direction) and up-down direction (Z-axis direction) of the first convex part 12, so the connecting agent such as solder or the like does not adhere to the second contact surface 63a due to the so-called solder rise. Furthermore, the insulating material that constitutes the first housing 11 is present between the aforementioned portion and the second contact surface 63a, so the connecting agent such as solder or the like can be more reliably prevented from adhering to the second contact surface 63a. In addition, the distance from the aforementioned portion to the first contact surface 65a adjacent to the second contact surface 63a is long in the width direction, longitudinal direction (X-axis direction), and up-down direction of the first convex part 12, and since insulating material constituting the first housing 11 is present, the connecting agent such as solder or the like does not adhere to the first contact surface 65a due to solder wicking.

In the present embodiment, the first terminals 61 are assumed to have a highly conductive metal such as gold, nickel, palladium, or the like that is typically used for connectors plated on the surface thereof to reduce electrical resistance. However, the end surface 62a of the tail part 62 of the first terminal 61, which is the cut surface created by being cut from the connecting arm 68a of the terminal carrier 68, is not plated.

With the first connector 10 and second connector 101 in a mated state, the first protruding end part 16 is a portion that functions as an insert convex part inserted in a mating recessed part 122 of the second protruding end part 121, described below, provided on the second connector 101 and the first reinforcing fitting 51 is integrally mounted thereto.

An extended end part 14 extending in the longitudinal direction is integrally connected to both longitudinal ends of the first convex part 12 of the side wall 18 in each half body part 10, and an embedded part 15 extending further in the longitudinal direction of the first convex part 12 is integrally connected to each extended end part 14. Note that the extended end parts 14 extend obliquely inward, while the embedded parts 15 extend in the longitudinal direction from an inwardly-eccentric position at the tip end of the extended end parts 14 and are positioned inward from the outer surface 12b of the first convex part 12. In other words, the extended end part 14 of the left half body part 10A extends obliquely in the right direction (Y-axis negative direction), while the embedded part 15 extends longitudinally from a position eccentric in the right direction at the tip of the extended end part 14. In addition, the extended end part 14 of the right half body part 10B extends obliquely in the left direction (Y-axis positive direction), while the embedded part 15 extends longitudinally from a position eccentric in the left direction at the tip end of the extended end part 14.

Furthermore, at least part of the extended end part 14 of the left and right half body parts 10 and the entire embedded part 15 are covered by a first protruding end part 16 formed from an insulating material such as a synthetic resin or the like. Specifically, the first protruding end part 16 is formed by performing insert molding with the embedded parts 15 of the right and left half body parts 10 arranged adjacent to one another and covered by the first reinforcing fitting 51. Thereby, a first protruding end part 16 integrating the extended end part 14, the embedded part 15, and the first reinforcing fitting 51 of the left and right half body parts 10 is formed, and the side walls 18 of the left and right half body parts 10 are joined together. The first protruding end part 16 does not necessarily cover the entire embedded part 15, but may cover the embedded part 15 to a degree sufficient to join the right and left half body parts 10. However, the entire embedded part 15 is preferably covered to increase the binding strength to the highest degree. It should be noted that the first protruding end part 16 is a member formed so as to be integrated with other members by insert molding and is not an independent member separate from other members. It should, however, be noted that, for convenience of description, the first protruding end part 16 in FIG. 2 is depicted as being an independent member.

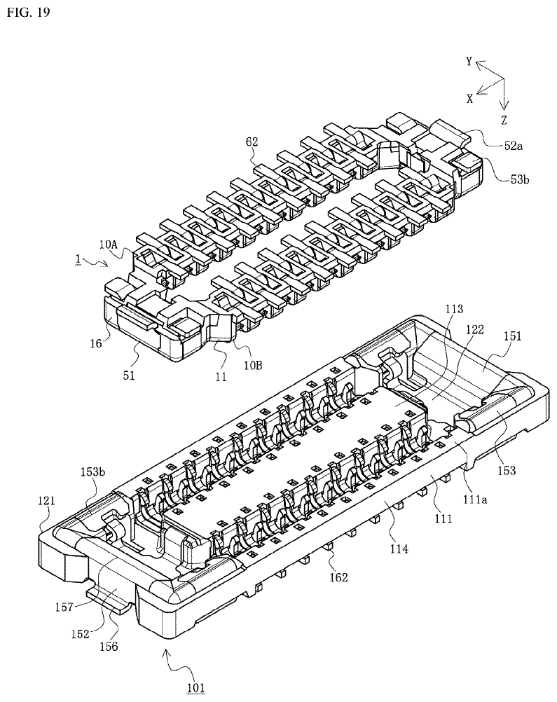

As depicted in FIGS. 8 and 19, the extended end part 14 has an upper surface 14a located on the upper side, an outer surface 14b and an inner surface 14c connected to the right and left ends of the upper surface 14a, and a lower surface 14d located on the lower side. The lower surface 14d is located above the lower surface 17c of the bottom plate part 17, and at least a portion is covered by the first protruding end part 16. The upper surface 14a is substantially flush with the mating surface 12a of the first convex part 12. Furthermore, the inner surface 14c is a surface inwardly oblique relative to the inner surface 12c of the first convex part 12. Furthermore, the outer surface 14b includes an inclined outer surface 14b1 inwardly oblique relative to the outer surface 12b of the first convex part 12, and a parallel outer surface 14b2 substantially parallel with the outer surface 12b of the first convex part 12. The parallel outer surface 14b2 is substantially flush with the outer surface of the first protruding end part 16, and constitutes a portion of the outer surface of the first protruding end part 16.

In addition, the embedded part 15 is a member provided with a substantially rectangular parallelepiped shape overall, having an upper surface 15a located on the top, an outer surface 15b and an inner surface 15c on both the left and right sides, a lower surface 15d located on the bottom, and an end surface 15e on both ends in the longitudinal direction of the first connector 1. The upper surface 15a and the lower surface 15d are flat surfaces parallel to each other. The distance between the upper surface 15a and the lower surface 15d, or in other words, the thickness of the embedded part 15, is less than the thickness of the extended end part 14 and the thickness of the first convex part 12. It should be noted that the upper surface 15a is located below the mating surface 12a, and the lower surface 15d is located above the lower surface 17c (mounting surface) of the bottom plate part 17. Furthermore, the outer surface 15b is a flat surface substantially parallel with the outer surface 12b of the first convex part 12 and is positioned inside relative to the outer surface 12b, in other words, closer to the middle in the width direction of the first housing 11. Furthermore, the inner surface 15c includes a parallel inner surface 15cl that is a flat surface substantially parallel to the inner surface 12c of the first convex part 12 and an inclined inner surface 15c2 substantially parallel to the inner surface 14c of the extended end part 14. The end surface 15e is a flat surface perpendicular to the first connector 1 in the longitudinal direction. Furthermore, the embedded part 15 is entirely covered by the first protruding end part 16, or in other words, is embedded within the first protruding end part 16.

In this manner, as the extended end part 14 extends inwardly at an oblique incline and the embedded part 15 is positioned inwardly from the outer surface 12b of the first convex part 12, the width (dimension in the Y-axis direction) of the first protruding end part 16 can be made smaller than the width (distance between the outer surface 12b of the left and right first convex part 12) of the first connector 1. Note that in the event the width of the first protruding end part 16 does not need to be smaller than the width of the first connector 1, the extended end part 14 does not necessarily have to be inclined obliquely inward, but rather can be extended directly. Furthermore, the extended end part 14 can be omitted by extending the embedded part 15 directly from both ends in the longitudinal direction of the first convex part 12. In this case, the longitudinal dimension of the first connector 1 can be shortened. Furthermore, when three or more half body parts 10 are arranged in parallel, the extended end part 14 can be extended so as to have a Y-shape from both ends in the longitudinal direction of the first convex part 12.

The first reinforcing fitting 51 is a member formed as a single unit by subjecting a metal plate to processing such as punching and bending, and includes a first main body part 52 which is a long, thin, band-shaped main body part extending in the width direction of the first housing 11, a pair of left and right side parts 53 connected to the first main body part 52 via bent connecting parts 52b formed on both the left and right ends of the first main body part 52, an upper plate part 54 which is connected to the upper edge of the first main body part 52 at an angle of approximately 90 degrees and extends toward the inside in the longitudinal direction (X-axis direction) of the first housing 11, and an end wall inner surface covering part 55 which is connected to the front edge of the upper plate part 54 at an angle of approximately 90 degrees and extends downward. It should be noted that a tail part 52a serving as a board connecting part extending outward in the longitudinal direction of the first housing 11 is connected to the lower edge of the first main body part 52 by being bent at approximately 90 degrees.

Furthermore, the side part 53 is a member shaped approximately like the number 9 when viewed in the longitudinal direction of the first housing 11. Furthermore, each side part 53 extends from the tip of the bent connecting part 52b toward the inside in the longitudinal direction of the first housing 11 and includes a flat main body part 53a extending in the vertical direction (Z-axis direction), a tail part 53b that is bent approximately 90 degrees and connected to the lower edge of the main body part 53a which serves as a board connecting part extending toward the outside in the width direction (Y-axis direction) of the first housing 11, and a contact part 53c that is bent approximately 180 degrees and connected to the upper edge of the main body part 53a and extends downward (negative Z-axis direction). The contact part 53c includes a flat contact side plate 53c2 which functions as a contact plate that contacts the contact arm part 154 of the second connector 101 described later, and a bent plate part 53cl which is bent approximately 180 degrees and connects the upper edge of the main body part 53a to the upper edge of the contact side plate 53c2.

It should be noted that the contact side plate 53c2 is spaced apart from the tail part 53b, and a void 53e is formed between the lower edge of the contact side plate 53c2 and the upper surface of the tail part 53b. In addition, the contact side plate 53c2 is also spaced apart from the main body part 53a, and a space 53d is formed between the widthwise inner surface of the first housing 11 at the contact side plate 53c2 and the widthwise outer surface of the first housing 11 at the main body part 53a.

As described above, the first reinforcing fitting 51 is integrated with the first protruding end part 16. Furthermore, the upper plate part 54 is embedded in the upper surface of the first protruding end part 16. In this state, the upper surface of the top plate part 54 is flush with the upper surface of the first protruding end part 16 and constitutes over half the area of the upper surface of the first protruding end part 16. Furthermore, the first main body part 52 and the end wall inner surface covering part 55 are embedded in the end wall outer surface and the end wall inner surface of the first protruding end parts 16. The respective outer surfaces of the first main body part 52 and the end wall inner surface covering part 55 are flush with the end wall outer surface and the end wall inner surface of the first protruding end part 16 and constitute over half of the end wall outer surface and the end wall inner surface of the first protruding end part 16. It should be noted that the side part 53 is embedded inside the first protruding end part 16 and is not exposed, except for the outer surface of the contact part 53c, the entire lower surface of the tail part 53b, and a portion of the upper surface of the tail part 53b.

Furthermore, the tail part 52a of the first main body part 52 and the tail part 53b of the side part 53 have the lower surfaces connected by soldering or the like to connection pads connected to conductive traces on the first board. Furthermore, the conductive trace is typically a power line. In this manner, in each first reinforcing fitting 51, three points, namely the tail part 52a of the first main body part 52 and the tail parts 53b of the side parts 53, are connected to the connection pads of the first board by soldering or the like, thereby improving the connection strength of the first reinforcing fitting 51 to the first board.

In the tail part 53b of the side part 53, a connecting agent such as solder or the like is applied to the lower surface, but the distance from the lower surface to the outer surface of the contact side plate 53c2 is long due to the presence of the main body part 53a and the bent plate part 53cl, so the connecting agent such as solder or the like does not adhere to the outer surface of the contact side plate 53c2 due to so-called solder wicking. In addition, a void 53e is provided between the upper surface of the tail part 53b and the lower edge of the contact side plate 53c2, so a connecting agent such as solder or the like applied to the lower surface of the tail part 53b is more reliably prevented from adhering to the outer surface of contact side plate 53c2. Furthermore, a space 53d is formed between the upper surface of the tail part 53b, the outer surface of the main body part 53a, and the inner surface of the contact side plate 53c2, and the insulating material that constitutes the first housing 11 is present within this space 53d, so the connecting material such as solder or the like does not adhere to the outer surface of the contact side plate 53c2 due to solder wicking.

A method to produce the first connector 10 configured as above will now be described.

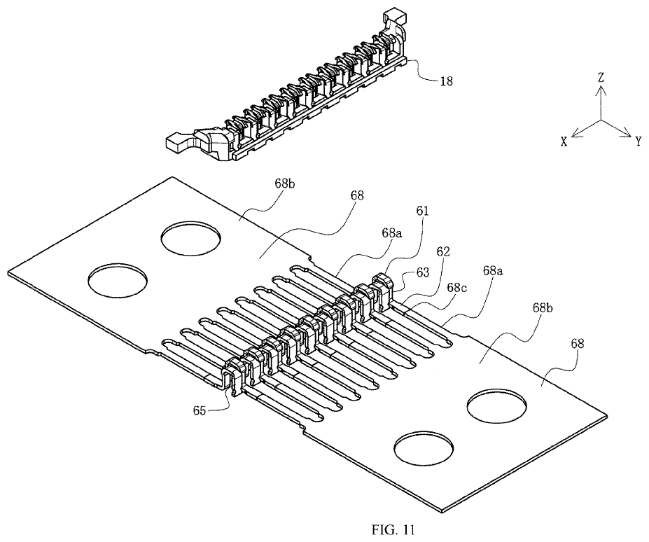

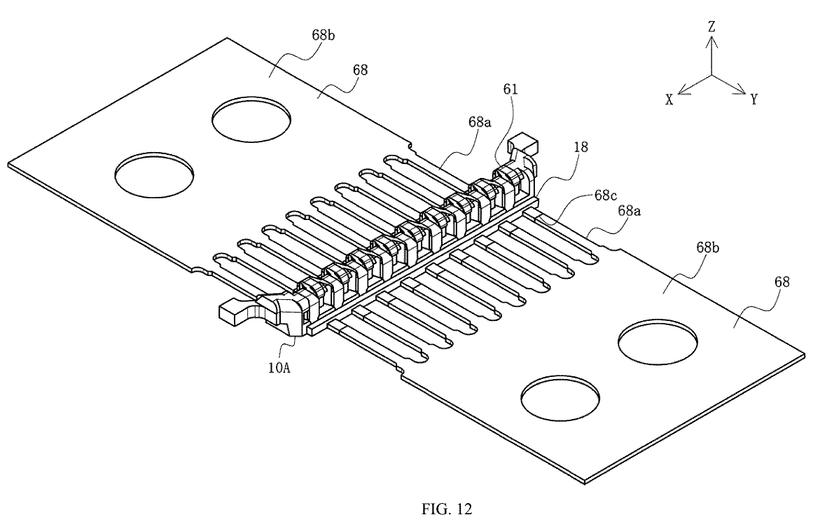

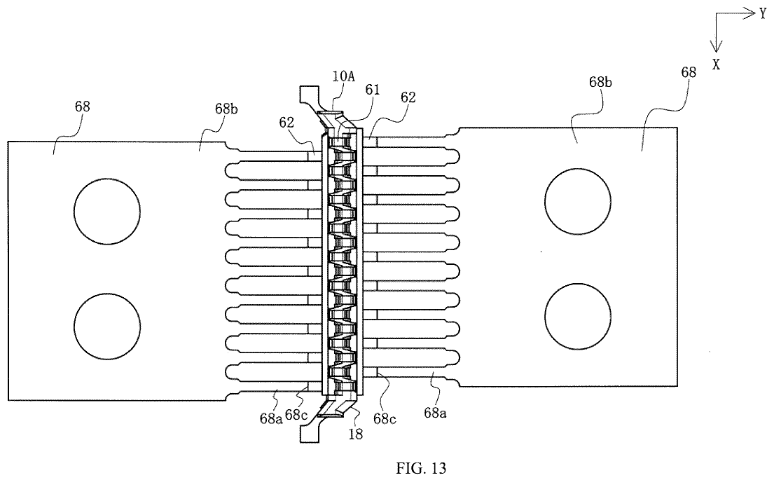

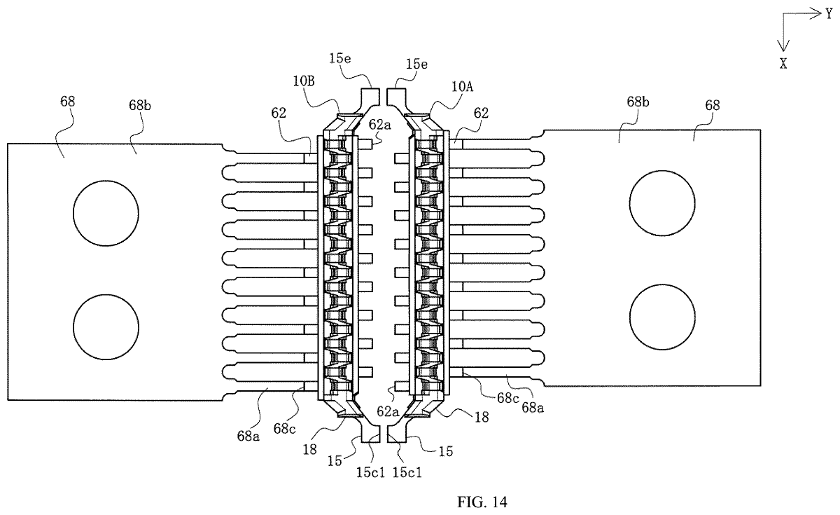

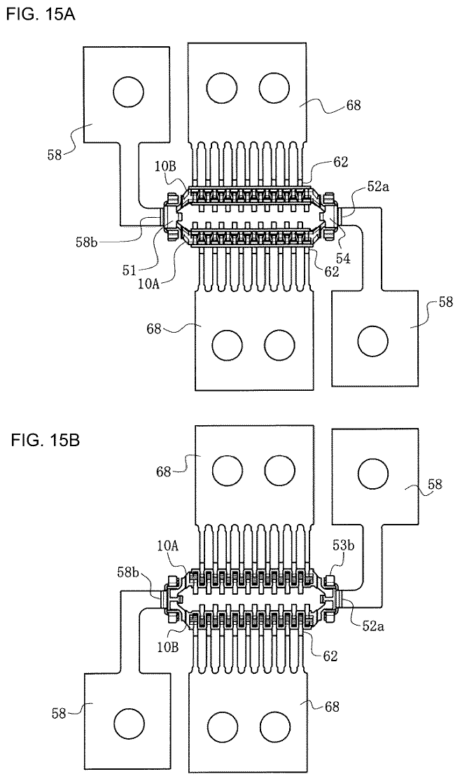

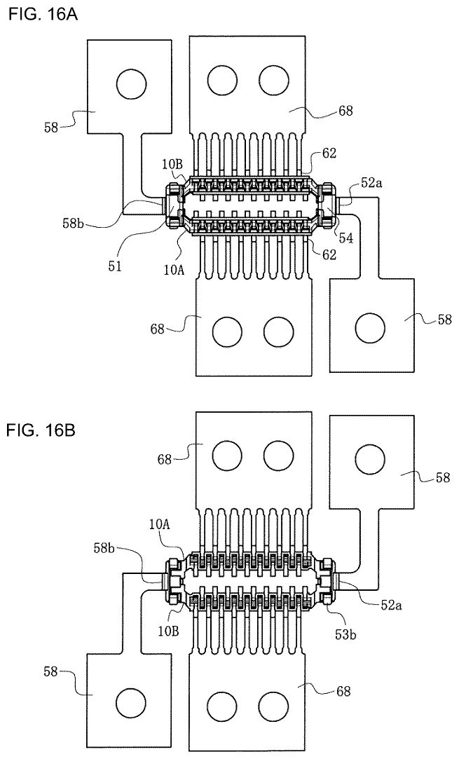

FIG. 11 is a perspective view depicting a first step of manufacturing the left half body of the first connector of the present embodiment, FIG. 12 is a perspective view depicting a second step of manufacturing the left half body of the first connector of the present embodiment, FIG. 13 is a plan view depicting the second step of manufacturing the left half body of the first connector of the present embodiment, FIG. 14 is a top view depicting the step of joining the left half body and right half body of the first connector of the present embodiment, FIGS. 15A and 15B are a two view diagram depicting the first step of manufacturing the first protruding end part of the first connector of the present embodiment, and FIGS. 16A and 16B are a two view diagram depicting the second step of manufacturing the first protruding end part of the first connector of the present embodiment. Note that in FIGS. 15A and 15B and FIGS. 16A and 16B, FIGS. 15A and 16A are a top view, and FIGS. 15B and 16B are a bottom view.

The first terminal 61 is a member made from a metal plate bent in the plate thickness direction and is made by processing a metal plate by punching, bending, and the like. As depicted in FIG. 11, the first terminals 61 are provided connected to a flat plate-shaped terminal carrier 68 as a carrier. Furthermore, each of the first terminals 61 is connected to the flat carrier main body 68b of the terminal carrier 68 via the elongated connecting arm 68a of the tail part 62, as depicted in FIG. 11, and by being separated from the connecting arm 68a at a cut part 68c, the tail part 62 is the type of member depicted in FIG. 2 and the like.

FIG. 11 depicts a terminal carrier 68 and a first terminal 61 corresponding to the terminal row 60 of the left half body part 10A in FIG. 1. Furthermore, the terminal carrier 68 on the lower right side (positive Y-axis direction) in FIG. 11 indicates the terminal carrier 68 and the first terminal 61 corresponding to the first terminal 61A of the terminal row 60 on the lower right side (positive Y-axis direction) in FIG. 3. Furthermore, the terminal carrier 68 on the upper left side (negative Y-axis direction) in FIG. 11 indicates the terminal carrier 68 and the first terminal 61 corresponding to the first terminal 61B of the terminal row 60 on the lower right side (positive Y-axis direction) in FIG. 3.

It should be noted that the side wall 18 in FIG. 11 is integrally molded with the first terminal 61 by insert molding and is not separate from the first terminal 61, and similar to the first housing 11 depicted in FIGS. 2 and 9, is depicted in this manner for the convenience of description.

Furthermore, in the process of being integrally molded with the first housing 11 by the first insert molding, first, the first terminals 61 are supplied in a state in which a plurality of first terminals 61 corresponding to the first terminals 61A are connected to one terminal carrier 68, as depicted in FIG. 11, and in a state in which a plurality of first terminals 61 corresponding to the first terminals 61B are connected to another terminal carrier 68, and then set in a molding die (not depicted). As a result, the first terminals 61A and the first terminals 61B are positioned in an alternating arrangement so as to form the terminal row 60 of the left half body part 10A in FIG. 1, and are set in the molding die. In this manner, the first terminals 61 can be simultaneously positioned and set in the mold for molding by holding and operating the terminal carriers 68 to which a plurality of first terminals 61 are connected.

Subsequently, melted insulating material, such as synthetic resin, is injected into the cavity of the mold for molding. The first insert molding is started in this manner. It should be noted that any kind of material may be used as the insulating material. In this example, liquid crystal polymer (LCP) is used. A material excellent in flowability is preferably selected for the first insert molding. Furthermore, when the injected insulating material is cooled and solidified so as to form the side wall 18 of the first housing 11, the mold for molding is opened and the left half body part 10A having the first terminals 61 connected to the terminal carriers 68 is removed, as illustrated in FIGS. 12 and 13. The right half body part 10B having the first terminals 61 in connection with the terminal carriers 68 is produced in the same manner.

Next, the connecting arm part 68a of the terminal carrier 68 (left terminal carrier 68 in FIG. 13) connected to the tail part 62 protruding in a direction corresponding to the inside of the first housing 11 (negative direction of the Y axis) is cut at the cut part 68c from the left half body part 10A with the terminal carrier 68 still connected to the first terminals 61 as depicted in FIGS. 12 and 13, and the terminal carrier 68 is removed, while the terminal carrier 68 (right terminal carrier 68 in FIG. 13) connected to the tail part 62 protruding in a direction corresponding to the outside of the first housing 11 (positive direction of the Y-axis) is left as is. Similarly, the terminal carrier 68 connected to the tail part 62 protruding in a direction corresponding to the inside of the first housing 11 is cut off from the right half body part 10B, with the terminal carrier 68 still connected to the first terminals 61, and the terminal carrier 68 connected to the tail part 62 protruding in a direction corresponding to the outside of the first housing 11 is left as is.

Next, as depicted in FIG. 14, the left half body part 10A and the right half body part 10B having only the tail parts 62 protruding in a direction corresponding to the outside of the first housing 11 in connection with the terminal carriers 68 are set opposite to each other in the mold (not depicted) for second molding. More specifically, the right and left half body parts 10 are set such that the insides thereof face each other, the side walls 18 of the right and left half body parts 10 are parallel to each other, the lower surfaces 17c of the bottom plate parts 17 of the side walls 18 of the right and left half body parts 10 are flush and the end surfaces 15e located at both ends in the longitudinal direction of the side walls 18 are flush, and the embedded parts 15 of the right and left half body parts 10 are proximal to but not in contact with each other. It should be noted that the opposing right and left half body parts 10 are positioned such that gap of the parallel inner surfaces 15cl of opposing embedded parts 15 are a predetermined distance and set in the mold for second molding.

Subsequently, the first reinforcing fitting 51 is set in the mold for second molding so as to cover at least a portion of the extended end parts 14 of the side wall 18 and all of the embedded parts 15 of the right and left half body parts 10. Specifically, the first reinforcing fitting 51 is set with the tip end of the tail part 52a connected with a fitting carrier 58 as a carrier. It should be noted that the first reinforcing fitting 51 is a member as depicted in FIG. 3 and is obtained by cutting off the tail part 52a from the fitting carrier 58 at a cut part 58b. Specifically, the first reinforcing fitting 51 is set so that a void is created between the upper plate part 54 and the upper surface 15a of the embedded part 15, the main body part 53a of the side part 53 is in contact or close to the outer surface 15b of the embedded part 15, a gap is created between the first main body part 52 and the end surface 15e of the embedded part 15, a gap is created between the end wall inner surface covering part 55 and the inclined inner surface 15c2 of the embedded part 15, and the lower surfaces of the tail parts 52a and 53b are below the lower surface 15d of the embedded part 15 and are at approximately the same height as the lower plate part 17a of the bottom plate part 17.

Subsequently, melted insulating material such as synthetic resin is injected into the cavity of the mold for molding. The second insert molding is started in this manner. It should be noted that the insulating material may be any kind of material. In this example, as with the first insert molding, LCP is used in light of flowability. The insulating material used for the second insert molding may be selected based on the strength and melt bondability with the insulating material of the first insert molding. Furthermore, when the injected insulating material is cooled and solidified so as to form the first protruding end part 16, the mold for molding is opened. The right and left half body parts 10 where both ends in the longitudinal direction of the side wall 18 are joined together by the first protruding end parts 16, as depicted in FIGS. 16A and 16B, are removed from the mold.

Finally, the remaining terminal carriers 68 and the fitting carriers 58 are cut off from the right and left half body parts 10 having both ends in the longitudinal direction of the side wall 18 joined together by the first protruding end parts 16, as depicted in FIGS. 16A and 16B. Consequently, the first connector 1 as illustrated in FIG. 1 is obtained.

Next, the configuration of the second connector 101 that forms a connector assembly together with the first connector 1 will be described.

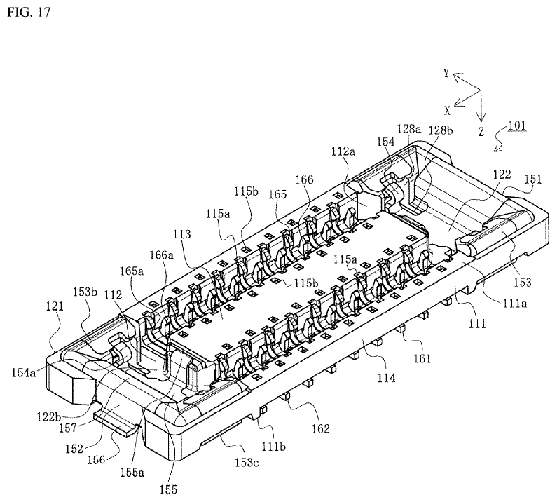

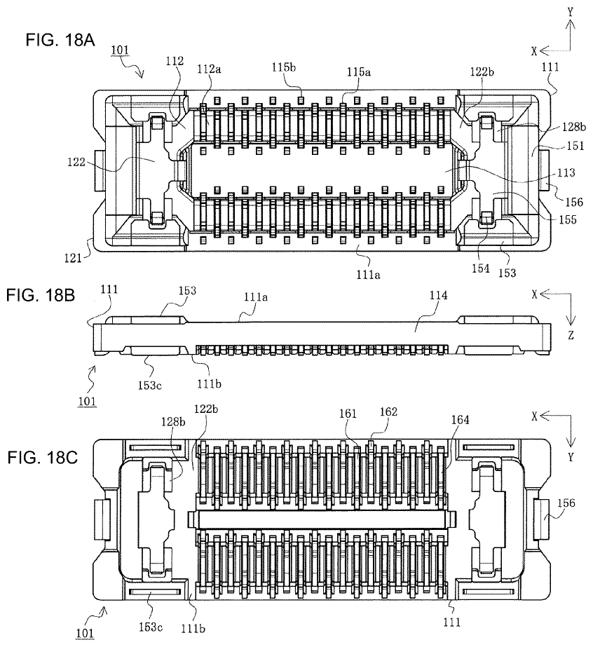

FIG. 17 is a perspective view of the second connector of the present embodiment. FIGS. 18A-18C are a three view diagram of the second connector of the present embodiment. Note that in FIGS. 18A-18C, FIG. 18A is a top view, FIG. 18B is a side view, and FIG. 18C is a bottom view.

The second connector 101, as a counterpart connector according to the present embodiment, has a second housing 111 as a counterpart housing integrally formed of an insulating material such as synthetic resin. As depicted in the figure, the second housing 111 has a substantially rectangular thick plate-like shape that is a substantially rectangular parallelepiped. Furthermore, the side of the second housing 111 into which the first connector 1 is inserted, in other words, the side of the mating surface 111a (Z-axis negative direction), is a substantially rectangular recessed part 112 with an enclosing periphery, forming the recessed part 112 to be mated with the first housing 11. Furthermore, the second convex part 113 is integrally formed with the second housing 111 as an insular part to be mated with the recessed groove part 13 in the recessed part 112. Moreover, the side wall parts 114 extending parallel with the second convex part 113 on both sides of the second convex part 113 are integrally formed with the second housing 111.

The second convex part 113 and the side wall parts 114 protrude upwardly (Z-axis negative direction) from the bottom surface of the recessed part 112 and extend in the longitudinal direction of the second connector 101. Consequently, a recessed groove part 112a that is an elongated recessed part extending in the longitudinal direction (X-axis direction) of the second connector 101 is formed as a portion of the recessed part 112 on both the sides of the second convex part 113.

A second terminal storage groove cavity 115a in the shape of a recessed groove is formed on the side surfaces of both sides of the second convex part 113 and the side surfaces of the inside of the side wall parts 114. In addition, a second terminal storage hole cavity 115b in the shape of a hole is formed on the second convex part 113 and the side wall parts 114. Furthermore, the second terminal storage groove cavity 115a and the second terminal storage hole cavity 115b are connected and integrated with each other on the bottom surface of the recessed groove part 112a. The second terminal storage groove-shape cavity 115a and the second terminal storage hole-shape cavity 115b are therefore described as a second terminal storage cavity 115 when collectively described. The second terminal storage cavities 115 are provided at a pitch corresponding to the first terminals 61 and at the corresponding appropriate number. Furthermore, each second terminal storage cavity 115 stores the second terminals 161 as counterpart terminals; thereby, the plurality of second terminals 161 are aligned in each recessed groove part 112a at a pitch and quantity corresponding to the first terminals 61 (18 pieces in the example depicted in the figures).

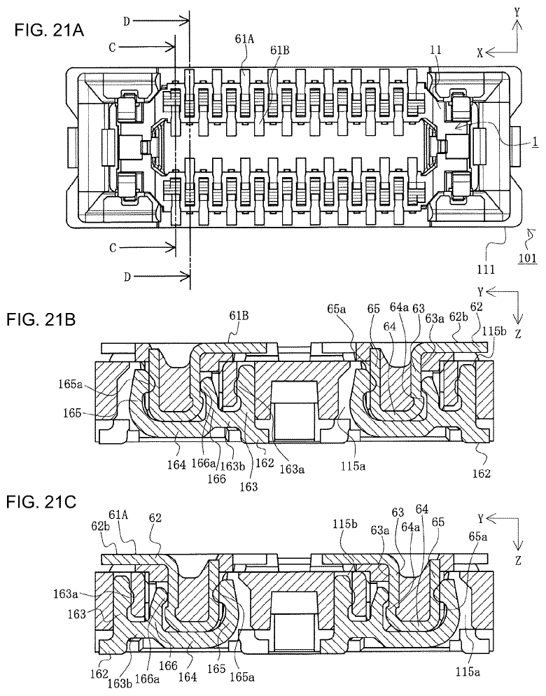

The second terminals 161 are members integrally formed by performing punching and similar processing on a conductive metal plate, and as clearly depicted in FIGS. 21A-21C described below, include: a main body part 163 extending in the up-down direction (Z-axis direction), a tail part 162 connected to the lower end (Z-axis positive direction end) of the main body part 163, a proximal connecting part 163b extending in the width direction (Y-axis direction) of the second connector 101 from close to the bottom end of the main body part 163, a proximal contacting part 166 as a first contact part connected near the lower end of the tip of the proximal connecting part 163b and extending in the up-down direction, a distal connecting part 164 extending from the lower end of the proximal contacting part 166 in the width direction of the second connector 101, and a distal contacting part 165 extending upward (Z-axis negative direction) from the tip end of the distal connecting part 164.

Note that a proximal contact convex part 166a and a distal contact convex part 165a are preferably formed facing each other near the tip ends of the proximal contacting part 166 and the distal contacting part 165. Furthermore, the main body part 163 is a portion that is press fit and retained in the second terminal storage hole cavity 115b and a mating convex part 163a for penetrating into the side surface of the second terminal storage hole cavity 115b is preferably formed near the tip end thereof.

In addition, the tail part 162 is bent and connected to the lower end of the main body part 163, extends in the width direction of the second housing 111, and is connected by soldering or the like to a connection pad that is connected to the conductive trace of the second board. Note that the conductive trace is typically a signal line but also may be a power line. Furthermore, the proximal contacting part 166 and the distal contacting part 165 are portions that contact the first terminals 61 provided in the first connector 1 when the first connector 1 and the second connector 101 are mated. The proximal contact convex part 166a and the distal contact convex part 165a contact the first contact surface 65a and the second contact surface 63a that are the contact surfaces of the first terminal 61, and preferably engage with the upper end convex part 64a.

The second terminal 161 is inserted into the second terminal storage cavity 115 from the lower part of the second housing 111 and mounted in the second housing 111. Therefore, the main body part 163 is press fit and retained in the second terminal storage hole cavity 115b, the proximal contacting part 166 and distal contacting part 165 are exposed in the recessed groove part 112a, and the lower surface of the tail part 162 of the second terminal 161 is exposed to a mounting surface 111b as the lower surface of the second housing 111.

In addition, the second terminals 161 mounted in each recessed groove part 112a constitute a terminal row extending in the longitudinal direction of the second connector 101 along each recessed groove part 112a, and in each of the terminal rows, adjacent second terminals 161 are aligned in an orientation so as to face each other in the width direction of the recessed groove part 112a. In the example depicted in FIGS. 17 and 18, of the second terminals 161 mounted in the recessed groove part 112a, the second terminals 161 positioned at the front end (end in the X-axis positive direction) are oriented such that the tail part 162 protrudes in the Y-axis negative direction, while the second terminals 161 positioned second from the front end are oriented such that the tail part 162 protrudes in the Y-axis positive direction. In this manner, as the second terminals 161 are mounted in the recessed groove part 112a arranged in a line in alternating directions, the pitch of the tail parts 162 exposed on the mounting surface 111b on both sides of the recessed groove part 112a is set to twice the pitch of the second terminals 161. Therefore, connection work by soldering or the like to the connection pad of the second board can easily be performed. In addition, the pitch of the proximal contacting part 166 and the distal contacting part 165 exposed to the recessed groove part 112a is two times the pitch of the second terminals 161.

In addition, the orientation of second terminals 161 mounted to each recessed groove part 112a adjacent in the width direction to the second connector 101 are set so as to face the same direction. In the example depicted in FIGS. 17 and 18, in both terminal rows on the Y-axis positive direction side and the Y-axis negative direction side, the orientation of the second terminal 161 positioned on the front end (X-axis positive direction end) is aligned such that the tail part 162 protrudes in the Y-axis negative direction, and the orientation of the second terminal 161 positioned second from the front end is aligned such that the tail part 162 protrudes in the Y-axis positive direction.

In addition, the second protruding end parts 121 are disposed as mating guide parts on both ends in the longitudinal direction of the second housing 111. The mating recessed parts 122 are formed as part of the recessed part 112 in each second protruding end part 121. The mating recessed parts 122 are substantially rectangular recess parts that are connected to both ends in the longitudinal direction of each recessed groove part 112a. Furthermore, the first protruding end part 16 provided on the first connector 1 is inserted in a state in which the first connector 1 and the second connector 101 are mated inside the mating recessed part 122.

Furthermore, a second reinforcing fitting 151 as a counterpart reinforcing fitting is attached to the second protruding end part 121. It should be noted that the second reinforcing fitting 151 is a component that is integrated with the second housing 111 by insert molding, and thus does not exist separate from the second housing 111, and the location on the second housing 111 where the second reinforcing fitting 151 is attached is not separate from the second reinforcing fitting 151.

The second reinforcing fitting 151 is a member integrally formed by performing punching, bending, and similar processes on a metal plate, and includes: a second main body part 152 extending in the width direction of the second housing 111, a side covering part 153 connected at both left and right ends of the second main body part 152, a pair of left and right tail parts 156 connected to the lower end of the second main body part 152, an end wall cover part 157 connected to an upper end of the second main body part 152, a recessed part cover part 155 connected to the end wall cover part 157, and a contact arm part 154 as a pair of left and right elastic members. The tail part 156 extends facing outwards in the longitudinal direction of the second connector 101 and is connected and secured to a connection pad (not depicted) by soldering or the like connected to a conductive trace on the second board. Note that the conductive trace is typically a power line but also may be a signal line. In addition, a lower end 153c of the side covering part 153 may get close to or come into contact with the surface of the second board, as necessary. In this case, the lower end 153c of the side covering part 153 is connected by soldering or the like to a connection pad of the second board, thereby increasing the strength of connection between the second reinforcing fitting 151 and the second board.

Upper ends of each of the side covering parts 153 are connected by a side wall upper cover part 153b. This side wall upper cover part 153b is bent more than 90 degrees and the tip thereof extends obliquely downward facing the inside of the mating recessed part 122. In addition, a contact convex part 154a is formed near an upper end, in other words, a tip of the contact arm part 154 as a contact part is formed in a shape so as to swell towards the center in the width direction of the second housing 111. Furthermore, an island end cover part 155a is connected to the tip of the recessed part cover part 155, centered in the width direction of the second connector 101.

Furthermore, the recessed part cover part 155 is stored in a bottom plate opening 128b formed penetrating a bottom plate 122b of the mating recessed part 122 in the plate thickness direction (Z-axis direction). In addition, the contact arm part 154 is stored in the bottom plate opening 128b and a side wall recessed part 128a formed on the inner surface of the mating recessed part 122 continuous with the bottom plate opening 128b. Note that the contact arm part 154 is not integrated with the second housing 111 and is stored in an elastically deformable state in the bottom plate opening 128b and the side wall convex part 128a. Therefore, the contact arm part 154 that functions as an elastic member has a long spring length and can exhibit a spring force, thus applying contact pressure on the contact convex part 154a for securely retaining the contact convex part 154a on the first reinforcing fitting 51.

In addition, the island end cover part 155a covers both ends of the second convex part 113, or in other words, the island ends, with at least the tip end part embedded. Therefore, both ends in the longitudinal direction of the second convex part 113 will not break when the first connector 1 and the second connector 101 are mated even if a portion comes into contact with the first connector 1.

Subsequently, the operation of mating together the first connector 1 and the second connector 101 with the above configuration will be described.

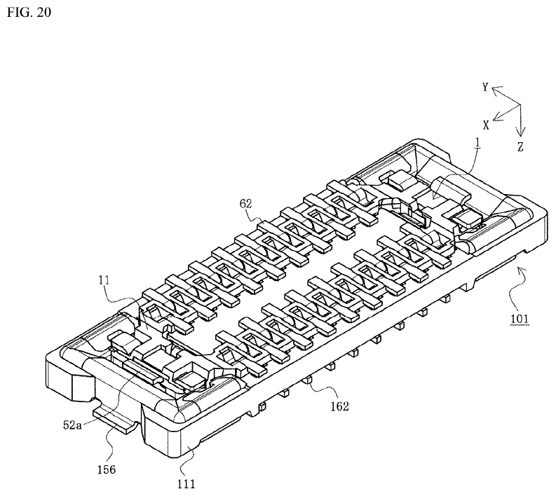

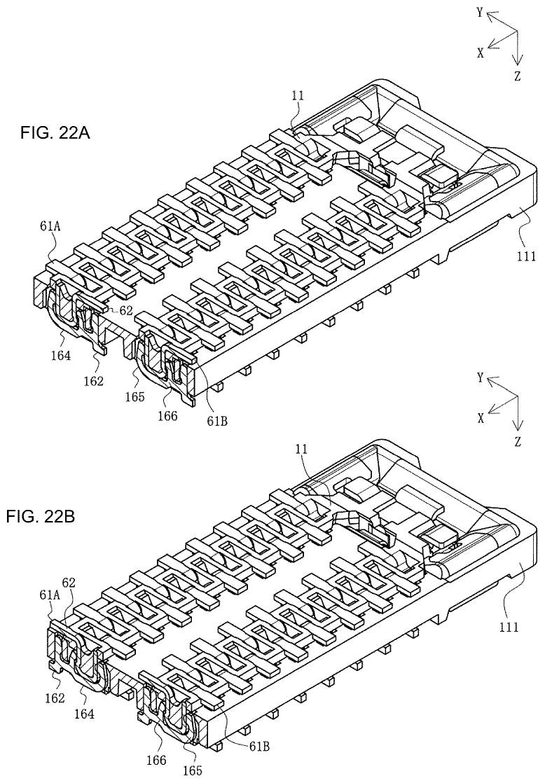

FIG. 19 is a perspective view viewed from the first connector side depicting the state immediately prior to the first connector and the second connector becoming mated according to the present embodiment. FIG. 20 is a perspective view viewed from the first connector side depicting the state of the first connector and the second connector in a mated state according to the present embodiment. FIGS. 21A-21C are a three view diagram depicting a state in which the first connector and second connector according to the present embodiment are mated. FIGS. 22A and 22B are a perspective view including a cross-section depicting the state in which the first connector and the second connector of the present embodiment are mated. It should be noted that in FIGS. 21A-21C, FIG. 21A is a plan view seen from the first connector side, FIG. 21B is a cross-sectional view as viewed along arrow C-C in FIG. 21A, and FIG. 21C is a cross-sectional view as viewed along arrow D-D in FIG. 21A. In FIGS. 22A and 22B, FIG. 22A is a perspective view including a cross-sectional view as viewed along arrow C-C in FIG. 21A, and FIG. 22B is a perspective view including a cross-sectional view as viewed along arrow D-D in FIG. 21A.

The first connector 1 is mounted on the surface of the first board with the tail parts 62 of the first terminals 61 connected by soldering or the like to a connection pad (not depicted) connected with a conductive trace of the first board, and with the tail part 52a of the first main body part 52 of the first reinforcing fitting 51 and the tail part 53b of the side part 53 connected by soldering or the like to a connection pad connected with a conductive trace of the first board. Note that the conductive trace connected to the connection pad to which the tail part 62 of the first terminal 61 is connected is a signal line, while the conductive trace connected to the connection pad to which the tail parts 52a and 53b of the first reinforcing fitting 51 is connected is a power line.

Similarly, the second connector 101 is mounted on the surface of the second board with the tail parts 162 of the second terminals 161 connected by soldering or the like to a connection pad (not depicted) connected with a conductive trace of the second board, and with the tail part 156 of the second reinforcing fitting 151 connected by soldering or the like to a connection pad connected with a conductive trace of the second board. Note that the conductive trace connected to the connection pad to which the tail part 162 of the second terminal 161 is connected is a signal line, while the conductive trace connected to the connection pad to which the tail part 156 of the second reinforcing fitting 151 is connected is a power line.

First, an operator opposes the mating surface 12a of the first convex part 12 as the mating surface of the first housing 11 of the first connector 1 and the mating surface 111a of the second housing 111 of the second connector 101, such that when the position of the first convex part 12 of the first connector 1 is aligned with the position of the corresponding recessed groove part 112a of the second connector 101 and when the position of the first protruding end part 16 of the first connector 1 aligns with the position of the corresponding mating recessed part 122 of the second connector 101, position alignment of the first connector 1 and the second connector 101 is complete.

In this state, when the first connector 1 and/or the second connector 101 are moved in a direction approaching the other side, in other words, in a mating direction, the first convex part 12 and the first protruding end part 16 of the first connector 1 are inserted into the recessed groove part 112a and the mating recessed part 122 of the second connector 101. Therefore, as depicted in FIGS. 20 to 22, mating of the first connector 1 and the second connector 101 is complete.

Furthermore, the first terminals 61 and the second terminals 161 are placed in a conductive state. Specifically, as depicted in FIGS. 21A-22C and FIGS. 22A and 22B, the inner column part 63, connecting part 64, and outer column part 65 of the first terminal 61 enter in between the corresponding proximal contacting part 166 and the distal contacting part 165 of each of the second terminals 161. Furthermore, the proximal contact convex part 166a of the proximal contacting part 166 and the distal contact convex part 165a of the distal contacting part 165 come into contact with the second contact surface 63a of the inner column part 63 and first contact surface 65a of the outer column part 65 that are contact surfaces.

Here, the distance from the second contact surface 63a to the first contact surface 65a for each first terminal 61 is larger than the distance from the proximal contact convex part 166a to the distal contact convex part 165a for the second terminal 161 so that when the inner column part 63, connecting part 64, and outer column part 65 of the first terminal 61 enter in between the corresponding proximal contacting part 166 and distal contacting part 165 of each second terminal 161, the second terminal 161 is elastically deformed, and the gap between the proximal contact convex part 166a and the distal contact convex part 165a increases. Therefore, by means of the repulsive force of the second terminal 161, the proximal contact convex part 166a and the distal contact convex part 165a are in a state of being pressed against the second contact surface 63a and the first contact surface 65a, reliably maintaining the contact between the proximal contact convex part 166a and distal contact convex part 165a and second contact surface 63a and first contact surface 65a. Thus, the conducting state between the first terminal 61 and the second terminal 161 is reliably maintained.

In this manner, with the present embodiment, the first connector 1 is provided with a first housing 11, a plurality of first terminals 61 attached in the first housing 11, and a first reinforcing fitting 51. Furthermore, the first housing 11 includes a pair of side walls 18 and a pair of first protruding ends 16 connected to each end of the side walls 18; the side walls 18 support a first terminal 61; the first reinforcing fitting 51 is connected to the first protruding end part 16; the first terminal 61 includes a tail part 62 extending in the width direction of the first connector 1, an inner column part 63 with one end connected to the tail part 62, and an outer column part 65 connected to the other end of the inner column part 63; and the side walls 18 include a bottom plate part 17 and a first convex part 12 extending from the bottom plate part 17 in the mating direction. A first contact surface 65a of the outer column part 65 is exposed to the outer surface 12b and the inner surface 12c of the first convex part 12 at a position corresponding to the outer surface 12b and the inner surface 12c of the first convex part 12; and a second contact surface 63a of the inner column part 63 is exposed to the outer surface 12b and the inner surface 12c of the first convex part 12 at a position offset toward the inside of the width direction of the first convex part 12 more than the outer surface 12b and the inner surface 12c of the first convex part 12.

Thus, the pitch of the first terminals 61 in the terminal row 60 is narrow, enabling narrowing of the gap of the terminal row 60 so solder wicking does not occur, manufacturing is simple, size reduction and a lower profile are feasible, and reliability of the first connector 10 is improved.

In addition, the bottom plate part 17 includes a lower plate part 17a, and a portion of the surface of the inner column part 63 side end of the tail part 62 is covered by the lower plate part 17a, and the end of the tail part 62 opposite the inner column part 63 is exposed to the outside of the lower plate part 17a when viewed from the mating direction. Thereby, the connection stability of the first connector 10 to the first board is improved.

Furthermore, one end of the inner column part 63 is connected to the outer column part 65 via the connecting part 64, and the other end of the inner column part 63 is embedded in the bottom plate part 17. Thereby, the amount and flow path of the insulating material during insert molding can be ensured, thus improving the manufacturing stability of the first connector 10.

Furthermore, the anchor part 65b of the outer column part 65 is embedded in the bottom plate part 17, and the lower surface 65c of the anchor part 65b is at least partially exposed when viewed from the lower surface 17c side of the bottom plate part 17. Thereby, the positional accuracy of the first terminals 61 and the manufacturing stability of the first connector 10 are improved.

Furthermore, the first terminals 61 supported by one side wall 18 and the first terminals 61 supported by the other side wall 18 at a position opposite to the first terminals 61 in the width direction of the first connector 1 have the same orientation when viewed from the longitudinal direction of the first connector 1. Thereby, the distance between the soldered points is increased, thus improving the connection stability of the first connector 1 to the first board.

In addition, the tail part 62 of the first terminal 61 supported by one side wall 18 and extending toward the other side wall 18, and the tail part 62 of the first terminal 61 supported by the other side wall 18 and extending toward one side wall 18 are arranged so as to be mutually shifted by half a pitch in a staggered pattern. Furthermore, the connector assembly includes a first connector 1 and a second connector 101 that mates with the first connector 1.

Note that the disclosure herein describes features relating to suitable exemplary embodiments. Various other embodiments, modifications, and variations within the scope and spirit of the claims appended hereto will naturally be conceived of by a person of ordinary skill in the art upon review of the disclosure herein.

The present disclosure can be applied to a connector and a connector assembly.

1. A connector, comprising:
a housing, a plurality of terminals and a reinforcing metal fitting attached to the housing, wherein
the housing includes a pair of side walls and a pair of end walls connected to each end of the side walls, the side walls supporting the terminals, and the reinforcing metal fitting connected to the end walls;
the terminal includes a board connecting part extending in a width direction of the connector, a second contact part with a first end connected to the board connecting part, and a first contact part with a second end connected to the second contact part;
the side wall includes a bottom plate part, and a convex wall protruding from the bottom plate part in the mating direction; and
the first contact surface having the first contact part is exposed to a first side surface and a second side surface of the convex wall at positions corresponding to the first side surface and the second side surface of the convex wall, and a second contact surface having the second contact part is exposed to a first side and a second side of the convex wall at positions offset inward in the width direction from the first side surface and the second side surface of the convex wall.

2. The connector according to claim 1, wherein the bottom plate part includes a flange, a portion of the surface of the second contact part side end of the board connecting part is covered by the flange, and the side end of the board connecting part opposite the second contact part is exposed outside the flange when viewed from the mating direction.

3. The connector according to claim 1, wherein the first end of the second contact part is connected to the first contact part via a connecting part, and the second end of the second contact part is embedded in the bottom plate part.

4. The connector according to claim 1, wherein a free end of the first contact part is embedded in the bottom plate part, and an end surface of the free end is at least partially exposed when viewed from the lower surface side of the bottom plate part.

5. The connector according to claim 1, wherein a terminal supported on a first side wall and a terminal supported on a second side wall at a position opposite to the aforementioned terminal in the width direction of the connector are in the same orientation when viewed from the longitudinal direction of the connector.

6. The connector according to claim 1, wherein the board connecting part of a terminal supported on the first side wall and extending toward the second side wall and the board connecting part of a terminal supported on the second side wall and extending toward the first side wall are arranged in a staggered pattern with a half pitch offset from each other.

7. An assembly, comprising the connector according to claim 1, and a counterpart connector that mates with the aforementioned connector.
